(19) United States
(12) Patent Application Publication
(10) Pub. No.: US 2009/0267940 A1
(43) Pub. Date: Oct. 29, 2009

(54) METHOD AND APPARATUS FOR CURVED MULTI-SLICE DISPLAY

(75) Inventors: Rohit Garg, Kirkland, WA (US); Dorothy Strassner, Redmond, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/374,560

(22) PCT Filed: Jul. 20, 2007
(86) PCT No.: PCT/IB07/52906

§ 371 Date: Jan. 21, 2009

(51) Int. Cl. G06T 15/00

(52) U.S. Cl. 345/419

(57) ABSTRACT

A method of generating a curved multi-slice display (50) comprises selecting a multi-planar reconstruction (MPR) source view from ultrasound data representative of a 3D volume of at least one structure in a body, generating a reference view (40) from the source view, the reference view including a reference point (42) on a curved reference line (44), wherein the curved reference line (44) corresponds to a curvature of the at least one structure, and generating a plurality of orthogonal slice views (46) from the ultrasound data along the curved reference line, the plurality of orthogonal slice views (46) being spaced apart from adjacent ones thereof and disposed along the curved reference line (44).

The present embodiments relate generally to medical ultrasound systems and more particularly, to a method and apparatus for curved multi-slice display.

Medical ultrasound systems can be used for a variety of diagnostic applications, for example, detecting spina bifida. A healthy spine is closed to protect the spinal cord. When a baby is growing inside its mother, the spine and spinal cord are developing. Sometimes, however, part of the spinal cord and spine grow abnormally, leaving an opening where the spinal cord is left unprotected. When this happens, a baby is born with spina bifida, which means “split or open spine.”

In the current state of the art, detection of spina bifida requires a detailed scan of a baby's spinal column. In addition, the detection of spina bifida is user skill dependent. For example, a 3D volume of the baby's spine can be acquired; however, the technician performing the acquisition of the 3D volume may not be an experienced technician/physician capable of detecting spina bifida.

Accordingly, an improved method and system for overcoming the problems in the art is desired.

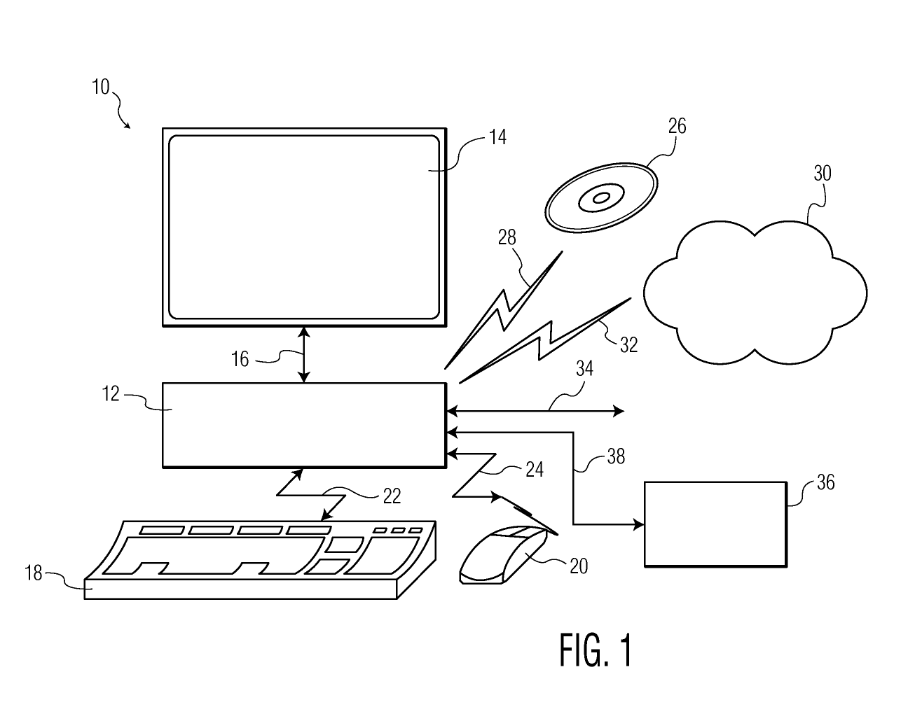

FIG. 1 is a block diagram view of a system for implementing the method of generating a curved multi-slice display according to the embodiments of the present disclosure;

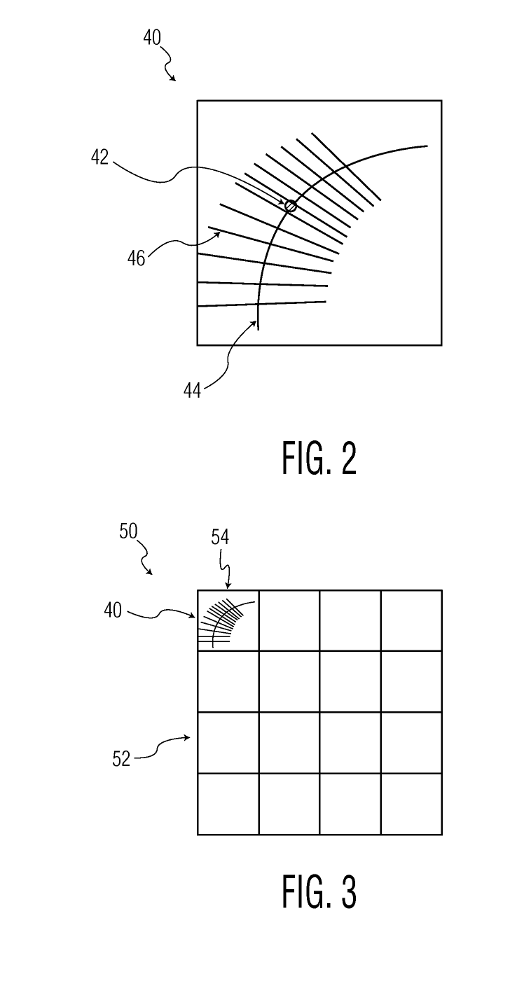

FIG. 2 is a simplified schematic diagram view illustrating a reference view of the curved multi-slice display according to an embodiment of the present disclosure;

FIG. 3 is a simplified schematic diagram view illustrating a multi-slice view of the curved multi-slice display according to an embodiment of the present disclosure;

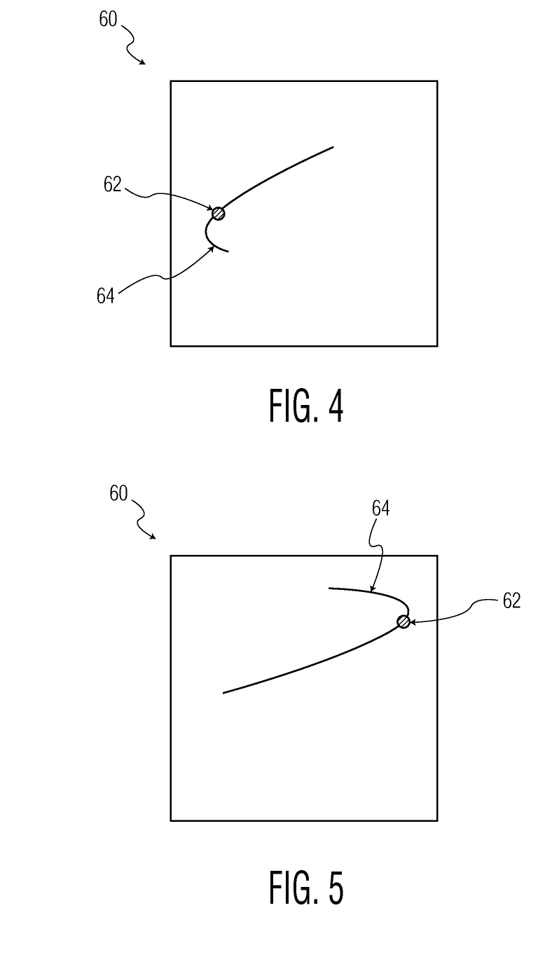

FIGS. 4 and 5 are simplified schematic diagram views illustrating various user selectable settings in connection with the reference view for use with the curved multi-slice display according to the embodiments of the present disclosure;

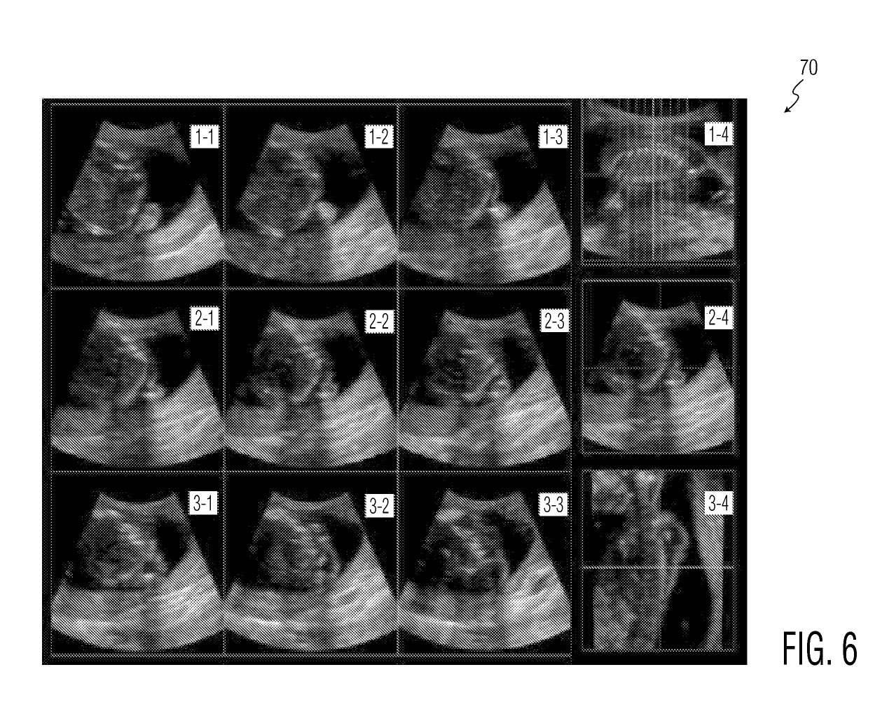

FIG. 6 is a illustrative view of a curved multi-slice display generated according to the embodiments of the present disclosure; and

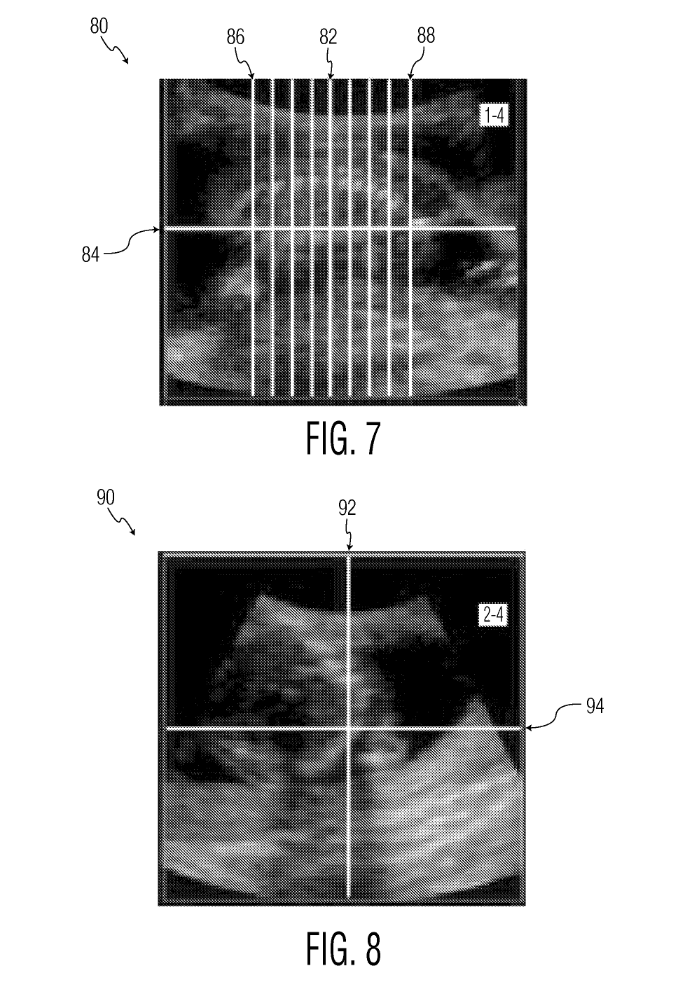

FIGS. 7, 8 and 9 are illustrative views of portions of the curved multi-slice display of FIG. 6, enlarged to show features in greater detail, according to another embodiment of the present disclosure.

In the figures, like reference numerals refer to like elements. In addition, it is to be noted that the figures may not be drawn to scale.

The embodiments of the present disclosure include creating a multi-slice display from a 3D ultrasound volume data based on a curved line. The multi-slice display from the 3D ultrasound volume data based on a curved line provides for the ability to quickly review multiple slices of any curved object along its longitudinal view. One target application for the multi-slice view of the present embodiments includes, for example, the detection of spina bifida.

According to the embodiments of the present disclosure, curved multi-slice display allows doctors and/or trained technicians to acquire a 3D ultrasound volume, for example, of a fetus's spine and display multiple longitudinal slices along the spine. Generation of the curved multi-slice display can either be done (i) at the end of the day by a doctor or trained technician, or (ii) at the time of scanning, saving all longitudinal slices for later review.

FIG. 1 is a block diagram view of a system for implementing the method of generating a curved multi-slice display according to the embodiments of the present disclosure. The method according to the embodiments of the present disclosure can also be implemented by a clinical workstation or other system for implementing a clinical task, as well as be produced in the form of a computer program product. Accordingly, FIG. 1 is a partial block diagram view of an apparatus 10 featuring curved multi-slice display according to an embodiment of the present disclosure. Apparatus 10 includes a computer/control unit 12, a display 14, wherein the display 14 is coupled to the computer/control unit 12 via a suitable connection 16. Apparatus 10 further includes an input/output device 18 and a pointing device 20, wherein the input/output device 18 and the pointing device 20 are coupled to the computer/control unit 12 via suitable connections 22 and 24, respectively. Suitable connections can comprise any suitable signal line or lines (wire, wireless, optical, etc.).

In addition, computer/control unit 12 comprises any suitable computer and/or control unit that can be configured for performing the various functionalities as discussed herein with respect to the method for generating a curved multi-slice display according to the various embodiments. Furthermore, programming of the computer/control unit 12, for performing the methods according to the embodiments of the present disclosure as discussed herein, can be accomplished with use of suitable programming techniques. Moreover, computer/control unit 12 interfaces with input/output device 18 (such as a keyboard, audio/voice input device, or similar device), pointing device 20 (such as a mouse, touch screen, or similar device) and display device 14, the computer/control unit for providing imaging data signals to the display for visual display.

The computer/control unit 12 may further send/receive data from one or more of a mass storage device or media 26 via suitable signal coupling generally indicated by reference numeral 28, and/or a computer network 30 (i.e., for remote data acquisition, storage, analysis, and/or display), etc., via suitable signal coupling generally indicated by reference numeral 32. The computer/control unit 12 may further receive data from one or more acquisition device and/or system (not shown), in addition to sending data to one or more device and/or system (not shown), via signal line 34. Still further, system 10 may include a printer device 36 coupled to computer/control unit 12 via signal line 38 for suitable use, as may be desired, during a particular procedure involving use of apparatus 10. Signal lines 34 and 38 can comprise any suitable signal line or lines (wire, wireless, optical, etc.).

With the embodiments of the present disclosure, the time needed to diagnose spina bifida can be considerably reduced over prior methods. In addition, the embodiments of the present disclosure provide for a 3D volume of a baby's spine to be acquired by a technician of less experience and then later analyzed by a more experienced technician/physician.

FIG. 2 is a simplified schematic diagram view illustrating a reference view 40 of the curved multi-slice display according to an embodiment of the present disclosure. The reference view 40 contains a reference point 42 on a curved reference line 44. Locations of orthogonal slices along the reference line 44 are indicated by reference numeral 46. In addition, the reference view comprises the reference plane.

FIG. 3 is a simplified schematic diagram view illustrating a multi-slice view 50 of the curved multi-slice display according to an embodiment of the present disclosure. Multi-slice view 50 includes a matrix of rows 52 and columns 54 of views, including at least reference view 40. The other views contained within the matrix of rows 52 and columns 54 will be explained further herein below with reference to FIGS. 6-9. In addition, the size of the matrix (number of rows; number of columns) can be selected according to the requirements of a desired diagnostic application. While the curved multi-slice view as illustrated appears similar to a regular multi-slice view, the curved multi-slice view differs by how the slices are selected and/or generated, as will be discussed further herein. For example, the slices in the curved multi-slice display are orthogonal to the reference line and reference plane. Furthermore, a regular multi-slice view is a degenerate case of curved multi-slice view when the reference line is a straight line.

In the multi-slice view, a source multi-planar reconstruction (MPR) view in the multi-slice display refers to a source view. The MPR view that shows annotation of all slices in the multi-slice view refers to the reference view. The multi-slice display method according to the embodiments of the present disclosure further comprises displaying a desired layout format according to the requirements of a given ultrasound diagnostic application. For example, the layouts can include a 2×2, 3×3, 4×4, 5×5, etc. layout. In addition, at least one slice in the multi-slice view in full screen mode contains the reference view.

FIGS. 4 and 5 are simplified schematic diagram views illustrating various user selectable settings in connection with the reference view for use with the curved multi-slice display according to the embodiments of the present disclosure. In one embodiment as illustrated in FIG. 4, the method includes generating a view 60 containing a reference point 62 and reference line 64 overlying an MPR view. The method further comprises selecting, via suitable means, the reference point 62 on the reference line 64. Still further, the method comprises changing, via suitable means, the curvature of the reference line 64. For example, the curvature of reference line may be changed from a curvature as illustrated in FIG. 2 to the curvature of FIG. 4. In addition, the method includes moving, via suitable means, the reference line 64. Still further, the method includes rotating, via suitable means, the reference line 64, for example, from the position as illustrated in FIG. 4 to the position of FIG. 5. Various features of the method as discussed herein are implemented in a manner to enable user selection thereof, as may be appropriate, for the requirements of a given diagnostic ultrasound imaging application.

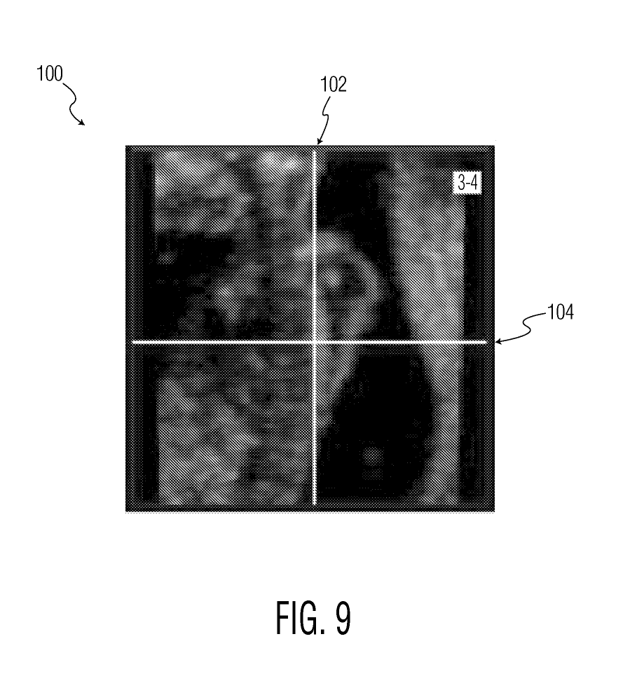

FIG. 6 is a illustrative view of a curved multi-slice display 70 generated according to the embodiments of the present disclosure. The curved multi-slice display 70 includes a matrix of views 1-1, 1-2, 1-3, 1-4, 2-1, 2-2, 2-3, 2-4, 3-1, 3-2, 3-3, and 3-4. In display 70, view 1-4 is representative of the reference view, which will be discussed further herein with reference to FIG. 7. Views 1-1, 1-2, 1-3, 2-1, 2-2, 2-3, 3-1, 3-2, and 3-3 represent the orthogonal slices taken along the reference line of view 1-4. View 2-4 is representative of the orthogonal view taken at the reference point along the reference line of view 1-4, which will be discussed further herein with reference to FIG. 8. In addition, view 3-4 is representative of another view derived from the reference view 1-4, which will be discussed further herein with reference to FIG. 9.

FIGS. 7, 8 and 9 are illustrative views of portions of the curved multi-slice display of FIG. 6, enlarged to show features in greater detail, according to another embodiment of the present disclosure. In view 80 of FIG. 7, view 1-4 of FIG. 6 is shown in enlarged detail, which is representative of the reference view. Included within view 80 is a center point longitudinal slice 82 along reference line 84. A plurality of spaced longitudinal slices is illustrated from reference numeral 86 to 88. In other words, a series of longitudinal slices along reference line 84 begins with slice 86 and ends with slice 88, wherein center point longitudinal slice 82 occurs at a central reference point in-between. In one embodiment, the spacing between adjacent longitudinal slices comprises a user selectable spacing.

In view 90 of FIG. 8, view 2-4 of FIG. 6 is shown in enlarged detail, which is representative of the orthogonal slice taken at the reference point along the reference line of view 1-4. In view 90, a vertical line (or axis) 92 and a horizontal line (or axis) 94 are illustrated. In view 100 of FIG. 9, view 3-4 of FIG. 6 is shown in enlarged detail, which is derived from the reference view 1-4. In view 100, a vertical line (or axis) 102 and a horizontal line (or axis) 104 are illustrated. The vertical and horizontal lines in any MPR plan view are provided to show where the other two MPR plan views intersect. Note that these two lines (or axes) are not required to always be vertical and horizontal, or perpendicular to one another. In other embodiments, these two lines (or axes) could be of any orientation, with respect to a given MPR plan and to each other.

The following discussion addresses the multi-slice view setup, navigation, and annotations in the method according to the embodiments of the present disclosure.

Multi-Slice View Setup

For multi-slice view setup, the method includes selecting, via suitable means, a source view for the multi-slice view. Selecting the source view can comprise, for example, using a user selectable source view selection tool for selecting the source view, further by means of a control on an input device or 3D control panel. The source view selection control can also comprise, for example, a pop-up list with values “1”, “2”, “3”, etc. In one embodiment, the default value of the source view selection tool comprises the value “1.”

The method also includes configuring, via suitable means, the multi-slice view in any one of a number of display layouts. Configuring the display layout can comprise, for example, using a user selectable display layout tool for controlling the display layouts, further by means of a 3D panel pop-up control. The display view layout configuration control can comprise, for example, “5×5”, “4×4”, “3×3”, “2×2”, etc. or other options as may be appropriate for a given diagnostic application.

The method further includes suitable means for selecting an interval between orthogonal slices and for changing the interval between slices. In addition, selecting and changing the interval can comprise a user selectable parameter. In one embodiment, the method includes providing a slider feature, whether in hardware on a panel or in software on-screen, wherein the slider provides control of the interval between adjacent orthogonal slices. In one embodiment, the control for the interval between slices comprises a default value of 1 mm. In addition, the method provides for changing, via suitable means, a depth of a center slice (corresponding to the orthogonal slice taken through the reference point on the reference line). In one embodiment, the method includes providing a slider feature for changing the depth of the middle slice, whether in hardware on a panel or in software on-screen, wherein the slider provides control of the depth of the middle slice. In one embodiment, the control for depth comprises a default value of the middle of the volume.

Multi-Slice View Navigation

For multi-slice view navigation, the method comprises selecting (for example, by left-clicking of a mouse or pointing device) a slice in the multi-slice view, wherein responsive to the selecting, the multi-slice view navigates the source MPR view to the current slice. The method further includes enabling the performing of measurements, when calibrated, on the MPR view. The measurements can include any desired user measurements on the MPR view (if calibrated). Furthermore, the method comprises selecting (for example, by double-clicking of a mouse or pointing device) anywhere in the multi-slice view, wherein responsive to the selecting, the multi-slice view displays in a full screen mode.

Furthermore, the method comprises reflecting in the multi-slice view any changes attributable to or in response to any changes to the orientation of the MPR views. For example, if the source view is MPR 1 and it is rotated, then all slices in the multi-slice view shall rotate accordingly.

The method further includes providing for user interaction with a slice in the multi-slice view similar to that in connection with a source MPR view. The user interaction can include, for example, rotate, pan, cine and orbit around the cross-hair contained within a respective view. The method further enables user interaction with any slice in the multi-slice view, subsequent to the user selecting a desired slice, i.e., prior to allowing implementation of any interactions. This advantageously reduces accidentally rotating or moving the reference point or dot with an unintentional initial click (i.e., a first mouse click) of the pointing device in an undesired location.

The method further enables user interaction with the first slice in the multi-slice view in full screen mode similar to a reference view. As a result, the method gives the user the capability to change the location of the slices in full screen without going back to a quad screen mode.

In a general imaging 3D quantification apparatus, according to another embodiment of the method of the present disclosure, if user selects a stacked contour measurement while in multi-slice view, correct source view, depth and interval shall be selected such that all slices appearing in stacked contours appear in the multi-slice view.

Scrolling up and down with a pointing device wheel (e.g., mouse wheel) changes the depth of the slices, for example, in connection with a cine capability. The user can arbitrate the mouse wheel to cine similar to MPR view and use a cine function. The cine function provides a moving cine of the source view and all the slices in the multi-slice view, keeping the currently selected slice the same. Furthermore, the method includes providing the ability for user selectable loop playback. Loop playback comprises, for example, playback of a Matrix Live 3D, Matrix Full volume, FETAL STIC, or Mechanical 4D loop in multi-slice view.

Multi-Slice View Annotations

For multi-slice view annotations, the method comprises providing one slice in the multi-view display, wherein the slice contains an MPR cross-hair representation (i.e., for user reference). In one embodiment, the top left slice of the multi-slice display contains the cross-hair representation. While displaying calibrated volumes, the method includes displaying the multi-slice display with scale markers on at least one slice. Preferably, the scale markers are displayed on the same slice on which the MPR cross-hairs are displayed. In addition, the method includes indicating a currently active slice in the multi-slice with use of bold colors. If there is no currently selected slice, the method includes highlighting the slice closest to the one in the source MPR view using dull colors. The method further includes changing the highlighting of the current slice with a smooth transition as the user slices (or advances) through the source view. In one embodiment, the smooth transition comprises on the order of three to four steps. For example, the smooth transition may include starting with bold color, dull color, two slices with dull color, next slice with dull color, next slice with bold color, etc.

Furthermore, the method includes labeling the reference lines on the reference view with the slice number, e.g., the first and the last slice. Accordingly, each slice on the multi-slice view can be labeled with a corresponding slice number. The selected slice in the multi-slice can display cross hairs similar to the source MPR view. In one embodiment, the cross hairs shall default to a partial cross hair.

In the general imaging 3D quantification apparatus, if a user selects a stacked contour measurement while in multi-slice view, slices corresponding to the stacked contours on the multi-slice view shall contain the user drawn contour.

According to the embodiments of the present disclosure, the curved multi-slice display provides a system user with the ability to quickly review a multiple of longitudinal slices of a curved object. The system user is able to take control by selecting a desired control point on a reference line within a reference view and changing the curvature of the reference line, further as may be desired. The slices contained within the multi-slice display comprise slices orthogonal to the reference line and a reference plane. According to a further embodiment, the method includes automatically detecting a curved object within a reference view and, in response to detecting the curved object, slicing the curved object along a reference line of the curved object. The later embodiment provides a simplified curved multi-view display operation for the system user.

According to another embodiment, a curved multi-slice rendering apparatus comprises a display; a computer/control unit coupled to the display, wherein the computer/control unit provides data to the display for rendering a curved multi-slice projection view; and an input device coupled to the computer/control unit for providing inputs to the computer/control unit, wherein the computer control unit is programmed with instructions for carrying out the method for producing curved multi-slice view as discussed herein.

According to yet another embodiment, a computer program product comprises computer readable media having a set of instructions that are executable by a computer for carrying out the method for producing a curved multi-slice view as discussed herein.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. A method of generating a curved multi-slice display comprising:
selecting a multi-planar reconstruction (MPR) source view from ultrasound data representative of a three-dimensional (3D) volume of at least one structure in a body;
generating a reference view from the source view, the reference view including a reference point on a curved reference line, wherein the curved reference line corresponds to a curvature of the at least one structure; and
generating a plurality of orthogonal slice views from the ultrasound data along the curved reference line, the plurality of orthogonal slice views being spaced apart from adjacent ones thereof and disposed along the curved reference line.

2. The method of claim 1, wherein the orthogonal slice views in the curved multi-slice display are orthogonal to the reference line and orthogonal to a reference plane.

3. The method of claim 1, wherein the MPR source view comprises a principal view for use in generating a curved multi-slice display view, the method further comprising:
generating the curved multi-slice display view on a display screen.

4. The method of claim 3, wherein the multi-slice display view comprises a matrix of rows and columns of image views, the image views including at least the reference view and the plurality of orthogonal slice views generated from the ultrasound data along the curved reference line.

5. The method of claim 4, further wherein the multi-slice display view comprises a desired layout format.

6. The method of claim 5, wherein the desired layout format comprises one selected from the group consisting of a 2×2, 3×3, 4×4, and 5×5 layout configuration.

7. The method of claim 5, further comprising:
selecting the desired layout format via a pop-up list on the display screen.

8. The method of claim 1, wherein the reference view illustrates an annotation of all orthogonal slice views in the curved multi-slice display view.

9. The method of claim 1, further comprising:
selecting a reference point on the reference line within the reference view.

10. The method of claim 1, further comprising one or more selected from the group consisting of:
(i) changing a curvature of the curved reference line within the reference view;
(ii) moving the curved reference line within the reference view;
(iii) rotating the curved reference line within the reference view; and
(iv) implementing one or more of the changing, moving, and rotating in a manner to enable user selection thereof according to the requirements of a given diagnostic ultrasound imaging application.

11. The method of claim 1, further comprising:
providing an interval slider feature, the interval slider feature for use in selecting an interval between adjacent ones of the plurality of orthogonal slice views, and further for changing the interval between slice views from a first interval to a second interval, different from the first interval.

12. The method of claim 11, wherein providing the interval slider feature comprises implementing the interval slider feature in one of hardware or software.

13. The method of claim 11, further wherein control of the interval between adjacent orthogonal slice views comprises a default value on the order of one (1) mm.

14. The method of claim 1, further comprising:
changing a depth of a center orthogonal slice view from a first depth to a second depth different from the first depth, the center orthogonal slice view corresponding to the orthogonal slice taken through the reference point on the curved reference line.

15. The method of claim 14, further comprising:
providing a center slice depth slider feature, the center slice depth slider feature for use in selecting the depth of the center orthogonal slice.

16. The method of claim 15, wherein providing the center slice depth slider feature comprises implementing the center slice depth slider feature in one of hardware or software.

17. The method of claim 15, wherein control of the depth of the center orthogonal slice comprises a default value corresponding to a middle of the 3D volume.

18. The method of claim 3, further comprising:
selecting an orthogonal slice view of the multi-slice view, and responsive to the selecting of the orthogonal slice view;
navigating the source MPR view to the selected orthogonal slice view;
generating a new reference view as a function of the selected orthogonal slice view;
generating a new plurality of orthogonal slice views as a function of the new reference view; and
generating a new curved multi-slice display view as a function of the new plurality of orthogonal slice views.

19. The method of claim 3, wherein responsive to any changes to an orientation of the MPR source view, the method further comprising:
reflecting corresponding changes in the curved multi-slice display view.

20. The method of claim 3, wherein responsive to a selection of an orthogonal slice view of the multi-slice display view and any changes to an orientation of the orthogonal slice view of the multi-slice display view, the method further comprising;
reflecting corresponding changes in the other orthogonal slice views of the multi-slice display view.

21. The method of claim 20, wherein responsive to an action selected from the group consisting of rotate, pan, cine and orbit around cross-hairs contained in the selected orthogonal slice view, the method reflects corresponding changes in the other orthogonal slice views of the multi-slice view by a similar action.

22. The method of claim 1, wherein the orthogonal slice views comprise a series of longitudinal slices along the reference line, wherein a center point longitudinal slice occurs at a central reference point in-between a first slice and a last slice in the series of longitudinal slices.

23. The method of claim 22, wherein a spacing between adjacent ones of the longitudinal slices comprises a user selectable spacing.

24. The method of claim 1, further comprising:
automatically detecting a curved object within a reference view and, in response to detecting the curved object, generating the plurality of orthogonal slice views of the curved object along the curved reference line corresponding to the detected curved object.

25. An apparatus comprising:
a display;
a computer/control unit coupled to the display, wherein the computer/control unit provides data to the display for rendering a screen view; and
means coupled to the computer/control unit for providing inputs to the computer/control unit, wherein the computer/control unit is programmed with instructions, responsive to said input means, for carrying out the method of generating a curved multi-slice display as claimed in claim 1.

26. A computer program product comprising:
computer readable media having a set of instructions that are executable by a computer for carrying out a method of generating a curved multi-slice display comprising:
selecting a multi-planar reconstruction (MPR) source view from ultrasound data representative of a three-dimensional (3D) volume of at least one structure in a body;
generating a reference view from the source view, the reference view including a reference point on a curved reference line, wherein the curved reference line corresponds to a curvature of the at least one structure; and
generating a plurality of orthogonal slice views from the ultrasound data along the curved reference line, the plurality of orthogonal slice views being spaced apart from adjacent ones thereof and disposed along the curved reference line.

27. The computer program product of claim 26, wherein method further comprises one or more selected from the group consisting of: (i) changing a curvature of the curved reference line within the reference view; (ii) moving the curved reference line within the reference view; (iii) rotating the curved reference line within the reference view; and (iv) implementing one or more of the changing, moving, and rotating in a manner to enable user selection thereof according to the requirements of a given diagnostic ultrasound imaging application.

28. The computer program product of claim 26, wherein the method further comprises:
providing an interval slider feature, the interval slider feature for use in selecting an interval between adjacent ones of the plurality of orthogonal slice views, and further for changing the interval between slice views from a first interval to a second interval, different from the first interval, and wherein providing the interval slider feature comprises implementing the interval slider feature in one of hardware or software.

29. The computer program product of claim 26, wherein the method further comprises:
changing a depth of a center orthogonal slice view from a first depth to a second depth different from the first depth, the center orthogonal slice view corresponding to the orthogonal slice taken through the reference point on the curved reference line; and
providing a center slice depth slider feature, the center slice depth slider feature for use in selecting the depth of the center orthogonal slice, wherein providing the center slice depth slider feature comprises implementing the center slice depth slider feature in one of hardware or software.

30. The computer program product of claim 26, wherein the MPR source view comprises a principal view for use in generating a curved multi-slice display view, and wherein the method further comprises generating the curved multi-slice display view on a display screen.
